(19) United States
(12) Patent Application Publication
(10) Pub. No.: US 2002/0138300 A1
(43) Pub. Date: Sep. 26, 2002

(54) Method of acknowledging supporters

(75) Inventors: John Hart, Belair (AU); Bruce Nankivell, Bridgewater (AU); Marcus Plowman, Stonyfell (AU)

Correspondence Address: OLIFF & BERRIDGE, PLC, P.O. BOX 19928, ALEXANDRIA, VA, 22320, US

(73) Assignee: SUPPORTERZONE PTY LTD., Unley (AU)

(21) Appl. No.: 10/137,304

(22) Filed: May 3, 2002

Related U.S. Application Data
(63) Continuation of application No. PCT/AU99/00969, filed on Nov. 5, 1999.

(51) Int. Cl. G06F 17/60

(52) U.S. Cl. 705/1; 705/14

(57) ABSTRACT

A method of acknowledging contributions to an organization or cause made by supporters, includes the steps of receiving from a plurality of supporters details of the supporters' names; entering the supporters' name details into a computer system; transferring the supporters' name details electronically directly onto a public use item or onto a printing plate or a camera-ready artwork print-out for printing on a public use item, wherein a “public use item” is a garment or item of sporting or other equipment which is to be used at a public event: and using the public use item bearing supporters' name details at one or more public events.

This invention relates to a method of acknowledging contributions to an organisation or cause made by supporters. It relates particularly but not exclusively to an automated Internet-based method in which a facilitator arranges the sponsorship of a sports person and/or organisation by a plurality of supporters.

There are numerous ways in which sporting sponsorship currently occurs. Frequently, a large commercial organisation agrees to sponsor a sports person or team in return for the sports person or team endorsing or advertising a product or service provided by the commercial organisation. The most common form of sponsorship is therefore a sub-branch of commercial advertising. The sports person or team aims to use the sponsorship to maximise income, and the sponsor aims to gain a commercial advantage by maximising advertising exposure through association between the sponsored person or team and the sponsor's product or service.

In some sports such as car racing and motorcycle racing, the sports person is often covered virtually from head to foot with advertising material. In other sports such as tennis or football, the sports person may carry smaller more discreet advertisements for sponsors. The value to the sponsor of the advertising exposure achieved through a sponsorship depends on such factors as the size and prominence of the advertisement, the frequency and length of time for which the sponsored sports person is shown in closeup on television, and how well the sports person performs.

In most cases, sponsorship of a sports person or team is not available to, or considered by, private individuals. Although many sports fans would very much like to have a more tangible way of demonstrating their allegiance to their sporting heroes, the cost of sponsorship is well beyond the means of most people, and (unlike many commercial organisations) private individuals usually have no commercial advantage to gain through advertising.

Private individuals often make gifts to charities, sporting clubs, educational institutions and the like, but on the whole such gifts go unrecognised apart from the issuing of a receipt and perhaps a listing of donors in a publication. The “telethon” has been devised as a method of providing recognition to people who give gifts to a cause, as a way of encouraging people to give, In a “telethon”, viewers of a television program are invited to phone in donations or pledges of donations, and the names of donors are read out over the television. This has been found to be an effective way for a charitable organisation to raise funds, but the recognition given to donors is very fleeting. In the case of a very large donation to a cause such as a hospital building fund, a donor may receive more permanent recognition by means of a plaque appearing on the building, but most private individuals do not have sufficient means to make gifts large enough to achieve that level of recognition.

There is a need for a method by which a sports fan or a supporter of an organisation or cause can have a more tangible experience of recognition for a contribution.

According to a first aspect of the invention, there is provided a method of acknowledging contributions to an organisation or cause made by supporters, including the following steps:

(a) receiving from a plurality of supporters details of the supporters' names;

(b) entering the supporters' name details into a computer system;

(c) transferring the supporters' name details electronically directly onto a public use item or onto a printing plate or a camera-ready artwork print-out for printing on a public use item, wherein a “public use item” is a garment or item of sporting or other equipment which is to be used at a public event; and

(d) using the public use item bearing supporters' name details at one or more public events.

The present invention provides a more tangible form of recognition to supporters by utilising modem technology. It can provide a means by which a supporter's name can be actually worn on a player's shirt during an important game, helping the supporter to feel that he or she has made a physical contribution to the success of the player. Similar results can be achieved in raising funds for many other causes such as, for example, humanitarian relief where the supporter's name could be printed on clothing given to refugees, or politics, where the supporters name could be printed on the political candidate's tie.

The supporters contribution may be recognised in one or more ways in addition to the printing of the supporter's name on the public use item. One such additional means of recognition may be by writing the supporter's name on an honour board. Another means of recognition may be provided if the method further includes the following additional step:

(e) providing to one or more of the supporters a replica of the public use item.

This additional step provides the supporter with a physical and tasting confirmation of the tangible nature of the contribution which the supporter has made. It enables the supporter to demonstrate his or her loyalty to the “cause” to friends and family. When the “public use item” is a garment such as a sporting shirt, the supporter can feel a special closeness to the sports person by wearing the replica.

The step of receiving details of supporters' names and the step of entering the supporters' name details may be accomplished in any suitable manner. In one embodiment of the invention, the step of receiving details of supporters' names includes providing an Internet web site which allows supporters to enter their details, and the step of entering the supporters' name details is conducted by the supporters themselves or persons associated with supporters entering their name details using the Internet web site.

In another embodiment of the invention, individual supporters are given at least the following choices as to how the steps of receiving details of supporters' names and entering supporters' name details are conducted:

(i) by the supporter or a person associated with the supporter entering the supporter's own name details using an Internet web site;

(ii) by the supporter or a person associated with the supporter providing the name details to an operator over the telephone, with the operator entering the name details into the computer system;

(iii) by the supporter or a person associated with the supporter providing the name details to an operator by mail, facsimile or another written form of communication, with the operator entering the name details into the computer system.

The name details may appear on the public use item in any suitable manner. In one embodiment of the invention, the name details which appear on the public use item are visible only when the names are viewed from close quarters, and the name details are blended into an overall colour pattern which appears on the public use item when viewed from a distance. The public use item may, for example, be a football jumper which has a particular colour pattern associated with a particular team. The colours, sizes and other details of names appearing on the jumper can be such that the overall appearance of the jumper when viewed from a distance is identical to a jumper in the same colours which does not have any names on it.

The step of receiving details of a supporter's name preferably includes receiving a payment from the supporter or a person associated with the supporter, so that the act of sponsorship is substantially contemporaneous with the placement of the supporter's name on the computer. There may, of course, be some delay between the act of sponsorship and the public use items being produced, and there will almost certainly be some delay between the act of sponsorship and the first occasion on which the public use item bearing the supporter's name details is used in public.

The public use them may be any suitable type of item. Suitable types of items include but are not limited to: warm-up jackets, helmets, T-shirts, jumpers, pullovers, sweat shirts, cloaks, track suits, jerseys, vests, footballs, basketballs, other types of balls, cricket bats, baseball bats, pads, gloves, flags, honour boards, racing vehicles, and sails on yachts.

According to a second aspect of the invention, there is provided an automated Internet-based method in which a facilitator arranges the sponsorship of a sports person or team by a plurality of supporters, including the following steps:

(a) The facilitator provides an Internet web site which gives details of one or more sports persons or teams who are available to be sponsored, and the costs associated with the sponsorship;

(b) The supporter or a person associated with the supporter visits the Internet web site, selects the sports person or team to be sponsored, enters the name details of the supporter, and makes a sponsorship payment;

(c) The name details of all supporters who have chosen to sponsor a particular sports person or team are automatically forwarded from the web site and formatted by a computer into a format ready for printing;

(d) The formatted name details are printed onto a plurality of garments;

(e) One of the garments is worn by the sports person or by members of the team during one or more public sporting events; and

(f) The other garments are forwarded to the supporters whose name details have been printed on the garments.

This aspect of the invention is more firmly focussed on sports sponsorship by private individuals in which the sponsorship is acknowledged on sporting garments worn by the sponsored sports person or team—although the same detailed method can be applied to non-sporting causes, and the acknowledgements may be printed on items which are not garments.

The invention will now be described in further detail with reference to the attached drawings which show example forms of the invention. It is to be understood that the particularity of the drawings does not supersede the generality of the preceding description of the invention.

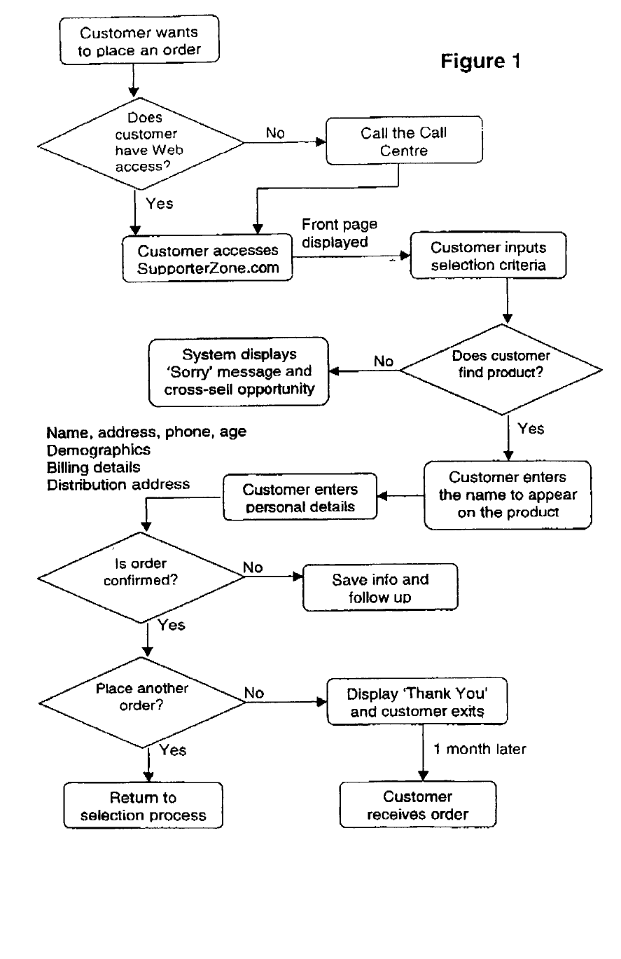

FIG. 1 is a flowchart showing the steps taken by a supporter (“customer”) in placing a sponsorship according to an embodiment of the invention. In this process it is assumed that the supporter wishes to order a copy of the product (in this case a shirt) on which the name details are to be placed.

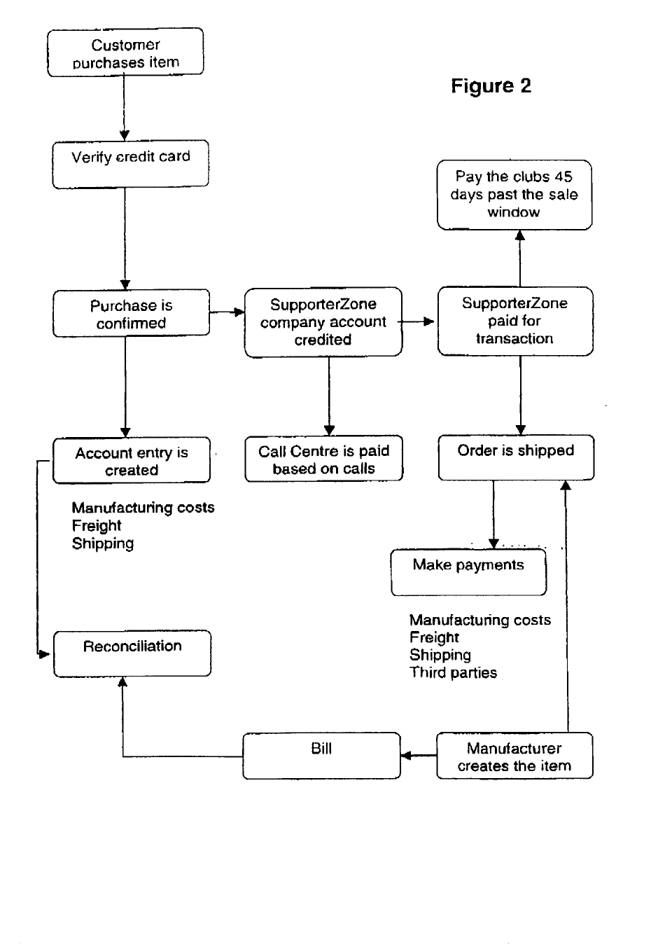

FIG. 2 is a flowchart showing the finance steps involved in an embodiment of the invention.

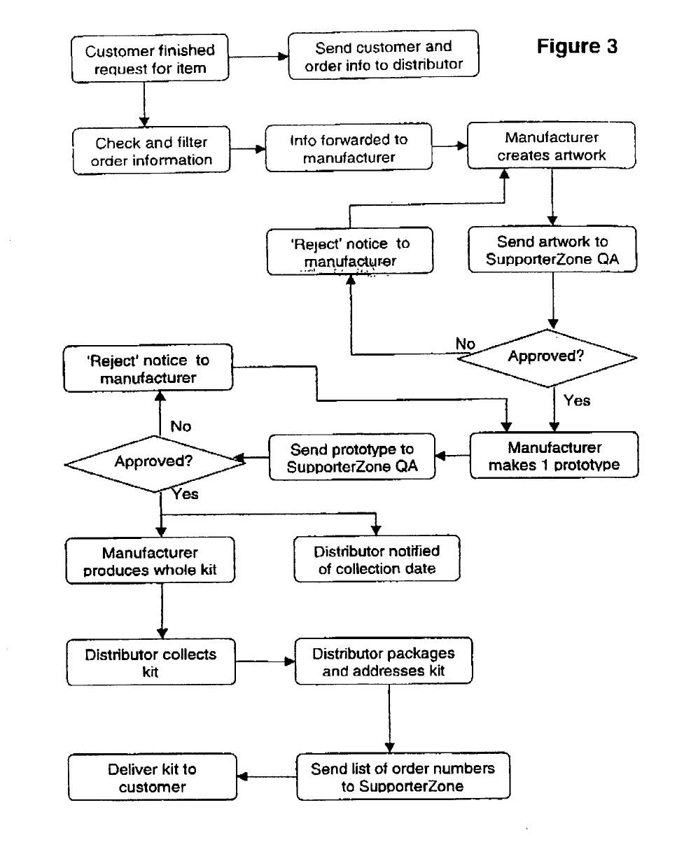

FIG. 3 is a flowchart showing the steps involved in manufacture and distribution of the shirt according to an embodiment of the invention.

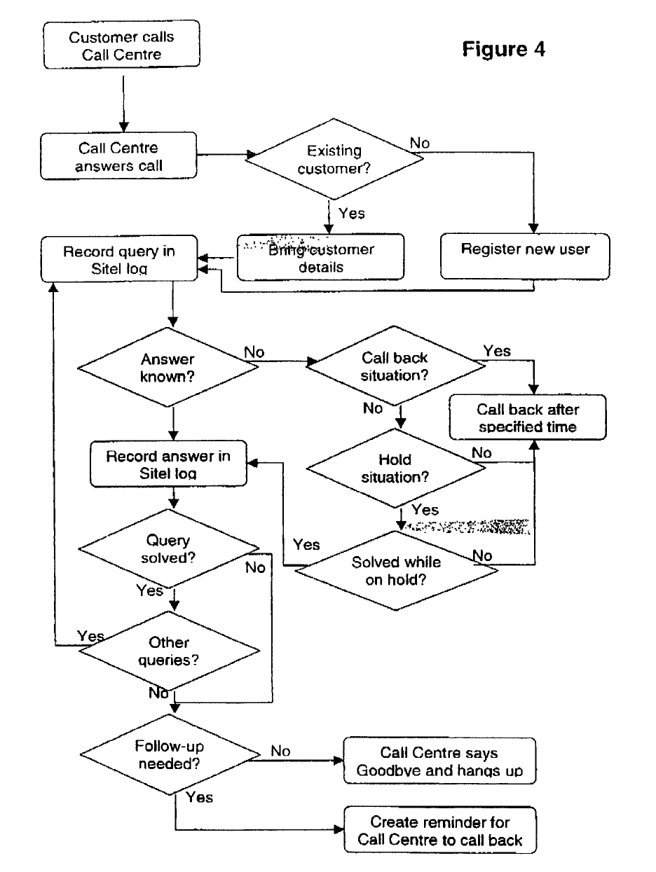

FIG. 4 is a flowchart showing a series of steps which may be taken to resolve difficulties in attempting to place an order through the Internet web site.

FIG. 5 is an illustration of a part of a warm-up jacket bearing a number of supporters' names according to an embodiment of the invention, showing how the jacket will appear when viewed from close up, and when viewed at a distance.

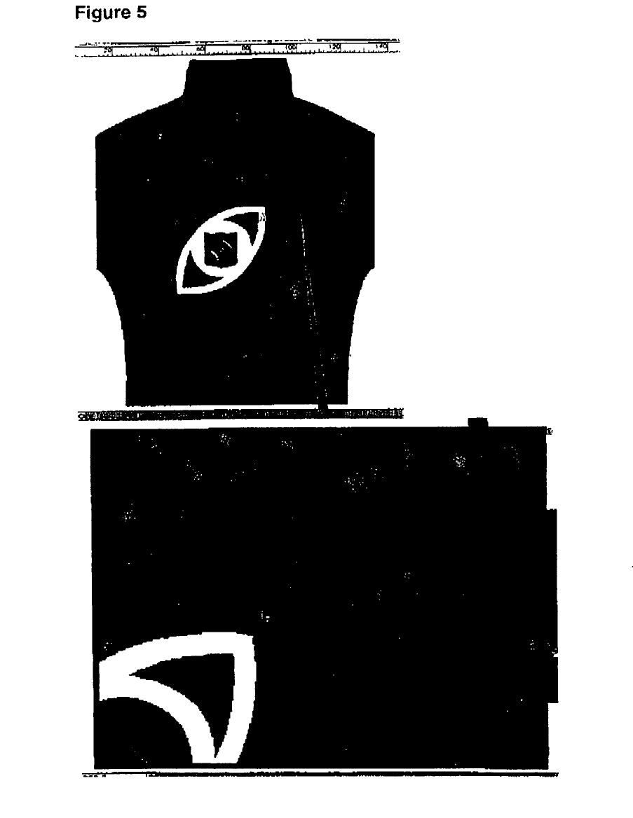

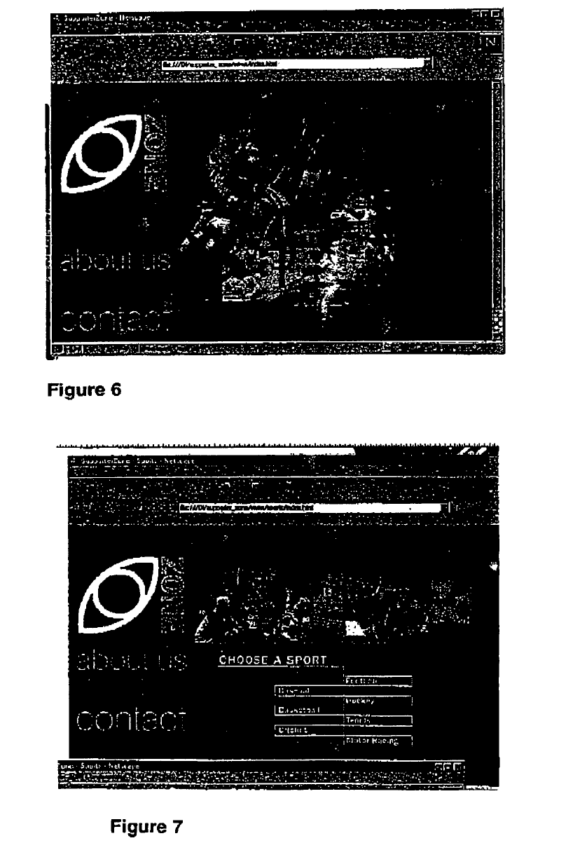

FIGS. 6 to 15 are screen dumps showing the steps involved in a supporter placing a sponsorship over the Internet.

According to the first aspect of the invention, the steps involved in acknowledging contributions made by supporters include the following:

(a) receiving from a plurality of supporters details of the supporters' names;

(b) entering the supporters' name details into a computer system;

(c) transferring the supporters' name details electronically directly onto a public use item or onto a printing plate or a camera-ready artwork print-out for printing on a public use item, wherein a “public use item” is a garment or portable item of sporting or other equipment which is to be used at a public event; and

(d) using the public use item bearing supporters' name details at one or more public events.

These steps of the invention are illustrated in detail by a combination of FIGS. 1, 2 and 3.

Referring firstly to FIG. 1, there is shown the steps in a supporter (here referred to as a “customer”) placing a sponsorship (here referred to as an “order”). If the customer has access to the Internet, he or she accesses the applicable Internet web site. In this example, the organisation which facilitates the sponsorship process is referred to as “Supporter Zone”, and the web site is referred to as “SupporterZone.com” or “SupporterZone.co.uk”. If the customer does not have access to the Internet, he or she calls a Call Centre by telephone, and an operator at the call centre takes the caller's details over the telephone and enters the caller's information into the Internet web site as if the caller had been doing so directly.

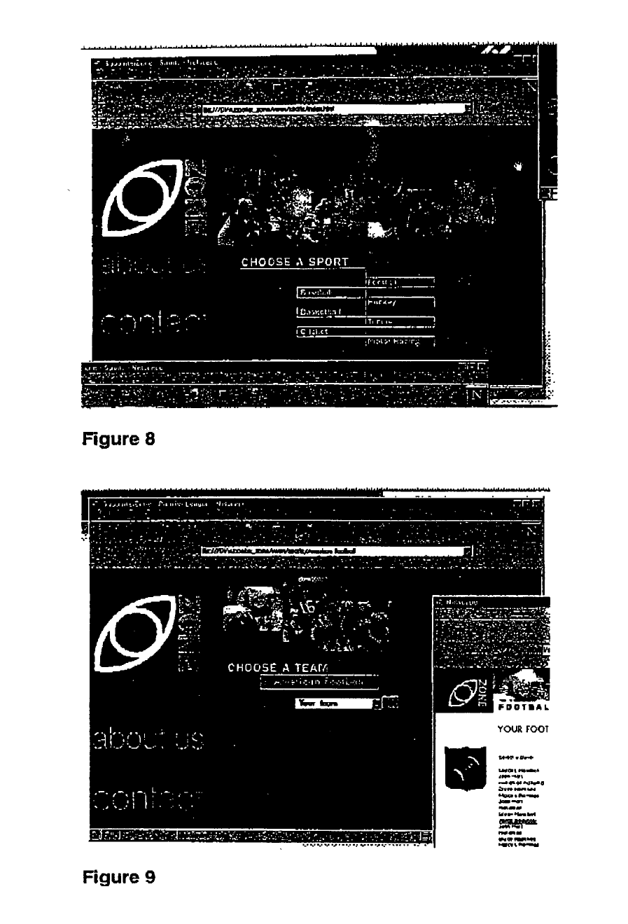

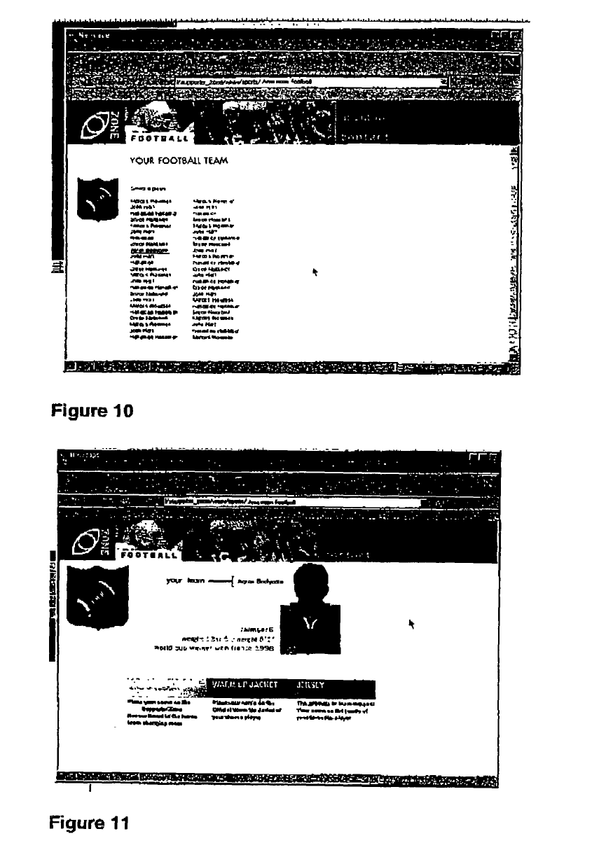

When the Internet web site is accessed, the front page is displayed. This is shown in FIG. 6. By clicking on the “Sports” option, the customer is directed to the page which appears as FIG. 7, which lists the different sports available. In this case, the customer selects football, and from the menu displayed in FIG. 8 chooses the option “English Premier League”, resulting in the display of the page shown in FIG. 9. From here the customer selects a team, and then from the menu of FIG. 10 he or she selects a player. Details of the player are then displayed (FIG. 11), and the customer then selects whether to have his or her name placed on the honour board in the home team changing room, on the players warm-up jacket, or on the player's jersey. In this case, the customer selects the jersey. If the customer does not locate a desired option, an appropriate message is displayed, as illustrated in the flow chart of FIG. 1.

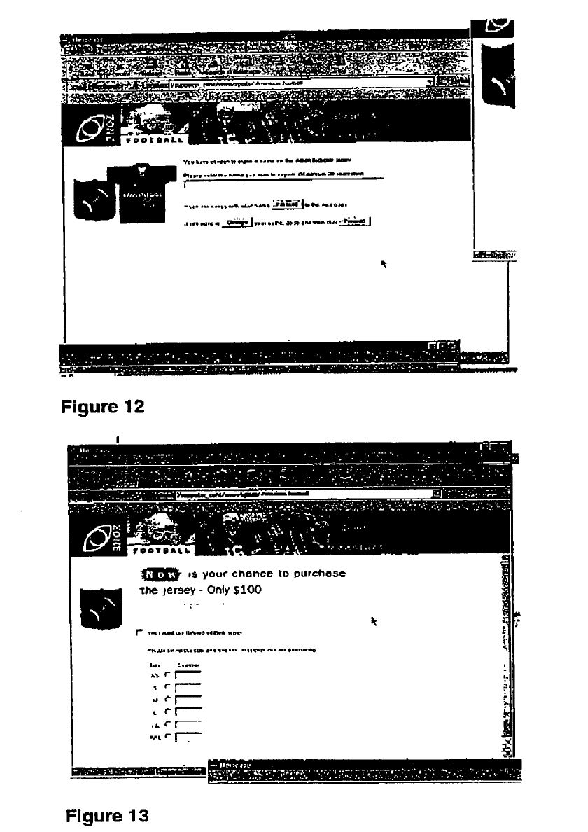

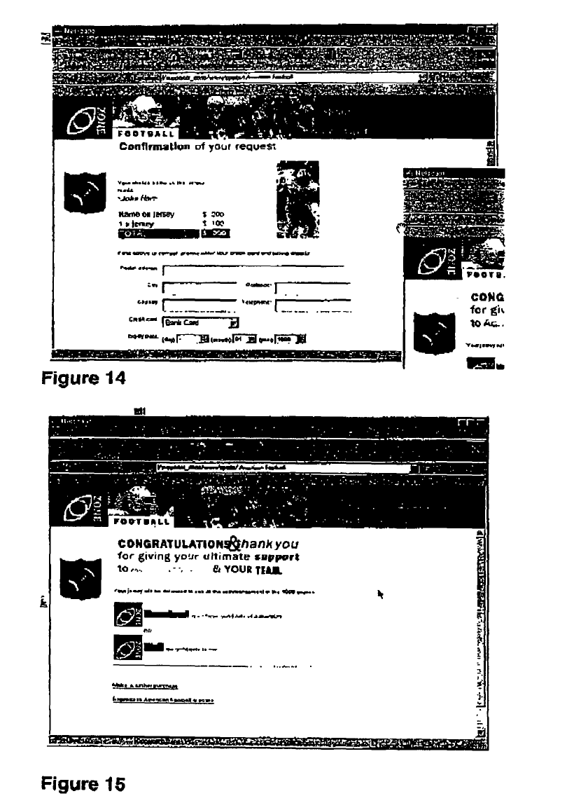

FIG. 12 shows an illustrative page onto which the customer can enter his or her name or, in the case of a gift sponsorship, the name of a friend or relative. FIG. 13 shows the next page, in which the customer is given the opportunity of ordering a replica of the jersey (as opposed to the option of simply sponsoring the player without receiving a replica jersey), and the customer enters size details (FIG. 13) and delivery address and payment details (FIG. 14). When these details have been validated, the page of FIG. 15 is displayed. giving the customer the choice of downloading a certificate or having one mailed.

Returning to FIG. 1, once the order has been confirmed the customer is offered the options of placing another order, linking to a club site, or exiting. According to the illustrative example, the jersey (if ordered) is delivered about one month later. In other examples, the delivery time may vary considerably.

FIG. 2 shows a flow chart of money through the process. When the customer makes a request to place a sponsorship (“purchase an item”), the customer's credit card details are verified. The purchase is confirmed, and an account entry is created, noting details of manufacturing costs, freight and shipping. The facilitator which operates the Internet web site (referred to as “Supporter Zone”) has its account credited with the sponsorship and purchase amount. Supporter Zone then pays direct from this account the costs of the Call Centre, which fields calls from customers who do not place orders over the Internet or who experience difficulties in doing so. After keeping sufficient funds to cover its costs and services, Supporter Zone forwards the balance to the clubs, individuals and organisations which are the beneficiaries of the sponsorship and sales. A manufacturer creates the shirts, and provides an account which is reconciled with the original account entries The orders are shipped, and payments are made to cover manufacturing costs, freight shipping and other costs.

Referring now to FIG. 3, the manufacturing and distribution process is shown in more detail, When a customer finishes placing a sponsorship and requesting a product, a copy of the customer and order information is sent directly to a distributor. Another copy of the information is checked and filtered automatically for duplicates, before being forwarded electronically to the manufacturer. The manufacturer uses the electronically provided information to automatically create the artwork for the product without reentering the names of the supporters. The artwork is sent back to Supporter Zone for approval, before a prototype is made, which is again subjected to quality approval before manufacturing of the batch proceeds. When the approval to proceed is given, a further notification is sent to the distributor indicating when the manufactured goods will be available for distribution. The distributor then collects the goods, packages and addresses them, notifies Supporter Zone, and delivers the goods to the customers.

Referring now to FIG. 4, there is shown a process for dealing with enquiries to the Call Centre when a customer has experienced difficulty with the web site. The call is answered. If the customer is not an existing customer, a new entry is created; otherwise the customer details are retrieved on computer. The query is recorded in a log. If the Call Centre cannot answer the query, the Call Centre may advise the customer that they will call back after a specified time. If an answer is known or found, the answer is recorded in the log. Depending on the result, a follow-up call may be required.

Referring now to FIG. 5, there is shown a warm-up jacket with a number of supporters' names on it. At the bottom of the Figure is a “close-up” section, which shows the listings of supporters' names. In different areas of the jacket, these names appear in different colours. The effect when the jacket is viewed from a distance can be observed in the top part of FIG. 5, where the jacket simply appears to contain the club's regular colour pattern, and individual names are not separately discernible.

It is to be understood that various alterations, additions and/or modifications may be made to the parts previously described without departing from the ambit of the invention.

1. A method of acknowledging contributions to an organisation or cause made by supporters, including the following steps.
(a) receiving from a plurality of supporters details of the supporters' names;
(b) entering the supporters' name details into a computer system:
(c) transferring the supporters' name details electronically directly onto a public use item or onto a printing plate or a camera-ready artwork print-out for printing on a public use item, wherein a “public use item” is a garment or item of sporting or other equipment which is to be used at a public event; and
(d) using the public use item bearing supporters' name details at one or more public events.

2. A method according to claim 1 further including the step of:
(e) providing to one or more of the supporters a replica of the public use item.

3. A method according to claim 1 or claim 2 wherein the step of receiving details of supporters' names includes providing an Internet web site which allows supporters to enter their details, and the step of entering the supporters' name details is conducted by the supporters themselves or persons associated with supporters entering their name details using the Internet web site.

4. A method according to claim 1 or claim 2 wherein individual supporters are given at least the following choices as to how the steps of receiving details of supporters' names and entering supporters' name details are conducted:
(i) by the supporter or a person associated with the supporter entering the supporter's own name details using an Internet web site;
(ii) by the supporter or a person associated with the supporter providing the name details to an operator over the telephone, with the operator entering the name details into the computer system;
(iii) by the supporter or a person associated with the supporter providing the name details to an operator by mail, facsimile or another written form of communication, with the operator entering the name details into the computer system.

5. A method according to any one of claims 1 to 4 wherein the name details which appear on the public use item are visible only when the names are viewed from close quarters, and the name details are blended into an overall colour pattern which appears on the public use item when viewed from a distance.

6. A method according to any one of claims 1 to 5 wherein the step of receiving details of a supporter's name includes receiving a payment from the supporter or a person associated with the supporter.

7. An automated Internet-based method in which a facilitator arranges the sponsorship of a sports person or team by a plurality of supporters, including the following steps:
(a) The facilitator provides an Internet web site which gives details of one or more sports persons or teams who are available to be sponsored, and the costs associated with the sponsorship;
(b) The supporter or a person associated with the supporter visits the Internet web site, selects the sports person or team to be sponsored, enters the name details of the supporter, and makes a sponsorship payment;
(c) The name details of all supporters who have chosen to sponsor a particular sports person or team are automatically forwarded from the web site and formatted by a computer into a format ready for printing;
(d) The formatted name details are printed onto a plurality of garments;
(e) One of the garments is worn by the sports person or by members of the team during one or more public sporting events; and
(f) The other garments are forwarded to the supporters whose name details have been printed on the garments.
